(19) United States
(12) Patent Application Publication
(10) Pub. No.: US 2019/0044436 A1
(43) Pub. Date: Feb. 7, 2019

(54) MULTI-PATH CAPACITOR DIVIDER

(71) Applicant: Dell Products L.P., Round Rock, TX (US)

(72) Inventors: Mohammed Hijazi, Austin, TX (US); Merle J. Wood, III, Round Rock, TX (US)

(73) Assignee: Dell Products L.P., Round Rock, TX (US)

(21) Appl. No.: 15/669,299

(22) Filed: Aug. 4, 2017

(51) Int. Cl. H02M 3/07; H02J 7/00

(52) U.S. Cl. CPC H02M 3/07; H02J 7/0081

(57) ABSTRACT

A multi-path capacitor divider circuit may select an input path for a capacitor divider based on a number of cells of a battery. The capacitor divider may then divide a voltage of power received from the battery based on the selected input path and may output power at a lower voltage as a result of the division. The capacitor divider may be coupled to the battery through a battery receptacle capable of receiving batteries of different configurations and different numbers of cells. The lower voltage output of the capacitor divider may be used by a high-frequency voltage regulator.

### FIELD OF THE DISCLOSURE

The instant disclosure relates to voltage dividers. More specifically, portions of this disclosure relate to configurable capacitor voltage dividers.

### BACKGROUND

As the value and use of information increase, individuals and businesses seek additional ways to process and store information. One option available for such a purpose is the information handling system. An information handling system generally processes, compiles, stores, and/or communicates information or data for business, personal, or other purposes thereby allowing users to take advantage of the value of the information. Because technology and information handling requirements vary between different users or applications, information handling systems may also vary regarding what information is handled, how the information is handled, how much information is processed, stored, or communicated, and how quickly and efficiently the information may be processed, stored, or communicated. Variations in information handling system build and capabilities allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may incorporate batteries to provide power when external power sources are unavailable. Power supplied from batteries may be adjusted and prepared for use by an information handling system by an internal voltage regulator. For example, a voltage regulator of an information handling system may receive power from a battery and adjust a voltage and/or current of power received by the system from the battery before outputting the power to various components of the information handling system.

Voltage regulators increase the size, weight, cost, and power consumption of an information handling system. To reduce the power consumption, cost, size, and weight contributed to information handling systems by voltage regulators, voltage regulators with higher switching frequencies may be implemented. For example, some voltage regulators may operate at switching frequencies greater than 2.5 MHz. Increasing switching frequencies of information handling system voltage regulators requires an input voltage from a battery that is less than is typically present in batteries.

Shortcomings mentioned here are only representative and are included simply to highlight that a need exists for improved information handling systems, particularly for improved voltage regulator input circuitry in information handling systems. Embodiments described herein address certain shortcomings but not necessarily each and every one described here or known in the art. Furthermore, embodiments described herein may present other benefits than, and be used in other applications than, those of the shortcomings described above.

### SUMMARY

An information handling system may incorporate a capacitor divider for dividing voltage from a battery of an information handling system for output to a voltage regulator of the information handling system. The capacitor divider provides the reduced voltages used by high-frequency voltage regulators. The capacitor divider may be a multi-path capacitor divider to accommodate multiple different possible battery voltages, while maintaining an approximately constant output voltage. For example, the information handling system may include multiple paths for coupling an output of a battery to an input of a capacitor divider. Each path may be configured to activate based on a specific voltage, range of voltages, or number of cells of a battery of the information handling system. Each path may be further coupled to a different input of the capacitor divider to obtain a relatively constant voltage output of the capacitor divider regardless of the number of cells or voltage of the battery.

A multi-path capacitor divider apparatus, such as one incorporated in an information handling system, may include a battery receptacle for receiving a battery. The battery receptacle may receive battery packs of multiple different configurations. A battery received by the receptacle may include one or more battery cells. The apparatus may further include a capacitor divider configured to divide a voltage output of the battery and to output the divided voltage at an output of the capacitor divider. The output of the capacitor divider may be coupled to an input of one or more voltage regulators such as a power management integrated circuit (PMIC) or one or more point-of-load voltage regulators, for example, to regulate power provided to an information handling system.

The apparatus may also include multiple paths for conducting power from the output of the battery to an input of the capacitor divider based on a voltage of the battery or a number of cells of the battery. For example, a first discharge path and a second discharge path of the apparatus may be coupled between an output of the battery receptacle and the input of the capacitor divider. The first discharge path may be coupled to a first input node of the capacitor divider, while the second discharge path may be coupled to a second input node of the capacitor divider. Thus, the first discharge path may apply a first divider ratio of the capacitor divider to a voltage output of the battery, while the second discharge path may apply a second divider ratio of the capacitor divider to the voltage output of the battery.

The second discharge path may be configured to activate when a number of cells of the battery is below a first threshold number of cells. For example, the second discharge path may activate when a battery comprising less than three cells is placed within the battery receptacle.

The number of cells of the battery may be indicated by a voltage of the battery, and the first threshold number of cells may be indicated by a threshold voltage. Thus, the second discharge path may be configured to activate when a voltage of the battery is less than a threshold voltage. The apparatus may further include a comparator, for determining whether the voltage of the battery is less than the threshold voltage. If the voltage of the battery is less than the threshold voltage, the comparator may activate the second discharge path, allowing current to flow from the battery to the capacitor divider through the second path.

The apparatus may include additional input paths for coupling the output of the battery to the input of the capacitor divider. For example, the apparatus may include a third discharge path from the battery receptacle to the capacitor divider. The third path may be configured to activate when a number of cells of the battery is greater than a second threshold number of cells and the first threshold number of cells. The first path may then be configured to activate when the number of cells of the battery is greater than the first threshold number of cells but less than the second threshold number of cells.

A method for dividing a voltage of a battery using a multi-path capacitor divider may include determining whether a number of cells of a battery falls below a threshold number of cells. Determining whether the number of cells of the battery falls below the threshold number of cells may be accomplished by determining a voltage of the battery and by comparing the voltage of the battery to a threshold voltage. If the voltage of the battery is below the threshold voltage, the number of cells of the battery may be below the threshold number of cells. If the number of cells of the battery is not below the threshold number of cells, power may be transmitted, via a first discharge path, to a capacitor divider configured to divide a voltage output of the battery and to output the divided voltage at an output of the capacitor divider. If the number of cells of the battery is below the threshold number of cells, a second discharge path from the battery to the capacitor divider may be activated and power may be transmitted via the second discharge path.

The first and second discharge paths may be coupled between the battery and the capacitor divider. Discharging power via the first path may include transmitting power from the battery to a first node of the capacitor divider, and discharging power via the second path may include transmitting power to a second node of the capacitor divider. The capacitor divider may divide a voltage received at the first node by a first divider ratio and may divide a voltage received at the second node by a second divider ratio. Such division may maintain an approximately constant output voltage from the capacitor divider, regardless of a number of cells or voltage of the battery.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an illustration of an example power input circuit according to some embodiments of the disclosure.

FIG. 2 is an illustration of a two-to-one capacitor divider according to some embodiments of the disclosure.

FIG. 3 is an illustration of a three-to-one capacitor divider according to some embodiments of the disclosure.

FIG. 4 is an illustration of a multi-path capacitor divider according to some embodiments of the disclosure.

FIG. 5 is an illustration of a multi-path capacitor divider configured to activate a path based on a voltage of a battery according to some embodiments of the disclosure.

FIG. 6 is an example method for selecting a path of a multi-path capacitor divider according to some embodiments of the disclosure.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, a two-in-one laptop/tablet computer, mobile device (e.g., personal digital assistant (PDA), smart phone, tablet computer, or smart watch), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more virtual or physical buses operable to transmit communications between the various hardware and/or software components.

Power received from a battery of an information handling system may have a greater voltage than a maximum voltage that a voltage regulator of the system is capable of processing. Thus, information handling systems may include capacitor dividers for dividing a voltage received from an internal battery and/or an external power source for delivery to one or more voltage regulators of the information handling system, to bring the voltage of power received from a battery within a range of voltages that the voltage regulator is capable of processing. For example, a power input circuit 100 of an information handling system, including a capacitor divider 116, is illustrated in FIG. 1. The system may receive power from an external power source, such as an AC adaptor or other external source, through power input 124. Charger 102 may sense power from the external power source through resistor 104 and may control field-effect transistor (FET) 106 and FET 108 to receive power from the external power source and deliver power to components of the information handling system through voltage regulator 118. An inductor 110 may be located between FET 106 and FET 108. The charger 102 may also control switch 112, which may be a metal-oxide-semiconductor field-effect transistor (MOSFET), to couple the battery 114 to the capacitor divider 116. The battery 114 may, for example, have a voltage ranging from 6V to 18V. In some embodiments, the battery 114 may be a two-cell battery, with a voltage ranging from below 6V to above 8.4V, a three cell battery, with a voltage ranging from below 9V to above 12.6V, or another battery with a different voltage. The battery 114 may, for example be a replaceable battery of a portable information handling system, such as a laptop computer. Power from the battery 114 may be delivered to capacitor divider 116 when charger 102 turns on switch 112. Capacitor divider 116 may divide the voltage received from the battery by a divider ratio of the capacitor divider 116. For example, if the battery 114 is a two-cell battery capacitor divider 116 may be a two-to-one capacitor divider and may divide the voltage of power received from the battery 114 by two. Alternatively, if the battery 114 is a three-cell battery capacitor divider 116 may be a three-to-one capacitor divider and may divide the voltage of power received from the battery 114 by three. Other capacitor dividers with different divider ratios may be included in a power input circuit based on a battery voltage and a desired voltage for input into a voltage regulator.

The divided voltage from the capacitor divider 116 may be passed to voltage regulator 118. Voltage regulator 118 may further adjust the voltage of the power received from the battery 114 to generate an output to power outputs 122A-D. Voltage regulator 118 may be a power management integrated circuit (PMIC), such as a high multiple output high-frequency voltage regulator (HFVR) PMIC, one or more point-of-load voltage regulators, or other voltage regulator. A voltage regulator 118 may operate at a high switching frequency, up to greater than 2.5 MHz, and may use an input voltage of 4.5V or less to operate at high switching frequencies. Thus, capacitor divider 116 may divide a voltage received by a battery to obtain an output voltage of 4.5V or less. Each of outputs 122A-D may output a different voltage from voltage regulator 118. Inductors 120A-D may be coupled between voltage regulator 118 and outputs 122A-D, and power outputs 122A-D may be coupled to one or more components of the information handling system.

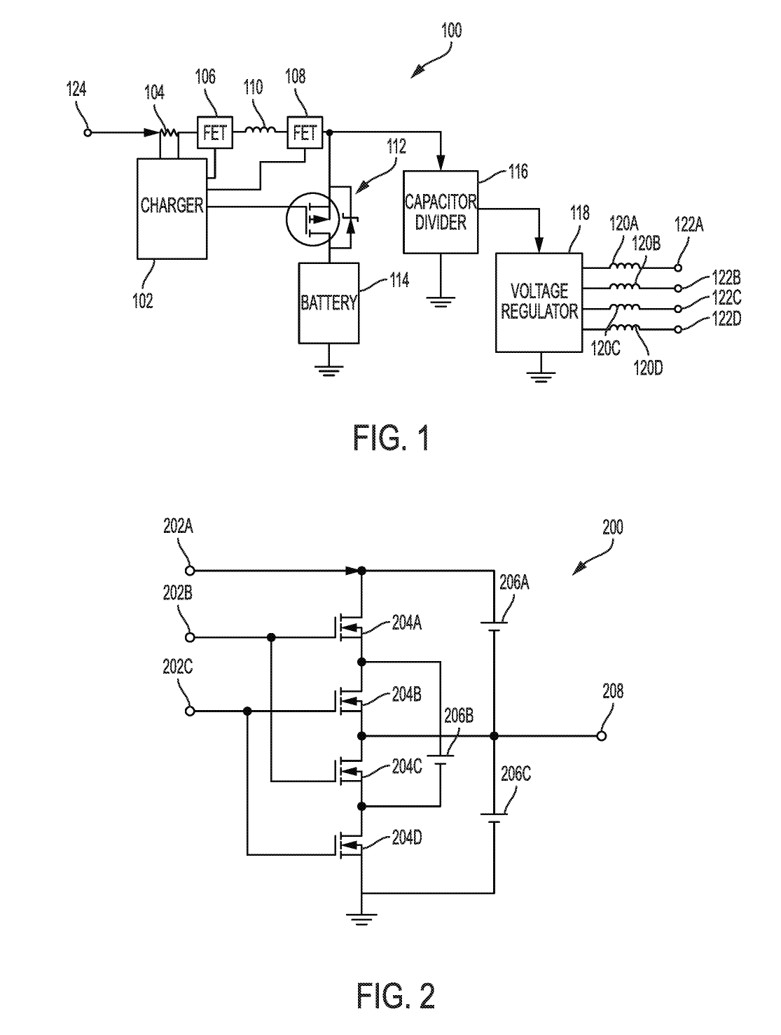

Different batteries may use different capacitor dividers to obtain a desired output voltage. More cells in a battery results in a higher voltage for the battery and thus more divisions to obtain a desired output voltage. For example, a two-cell battery may use a capacitor divider with a two-to-one divider ratio, such as capacitor divider 200 illustrated in FIG. 2, to obtain a desired voltage output. Capacitor divider 200 may receive an input voltage at input node 202A from a voltage source, such as a battery of an information handling system. The voltage input may be, for example, a voltage input from a two-cell battery between 6V and 8.4V. The capacitor divider 200 may receive timing signal inputs at input nodes 202B-C. For example, asynchronous digital pulse timing signals may be received at input node 202B and input node 202C. Input node 202A may be coupled to a first terminal of a switch 204A and a first terminal of a capacitor 206A. Input node 202B may be coupled to a second terminal of switch 204A to control current flowing from the first terminal of switch 204A to the third terminal of switch 204A. Input node 202B may be further coupled to a second terminal of a switch 204C to control current flowing from a first terminal to a third terminal of switch 204C. Input node 202C may be coupled to a second terminal of a switch 204B to control current flowing from a first terminal to a third terminal of switch 204B. Input node 202C may be further coupled to a second terminal of a switch 204D to control current flowing from a first terminal to a third terminal of switch 204D. The third terminal of switch 204A may be coupled to the first terminal of switch 202B and a first terminal of a capacitor 206B. The third terminal of switch 204B may be coupled to the first terminal of switch 204C, the second terminal of capacitor 206A, a first terminal of capacitor 206C, and an output 208 of the capacitor divider 200. The third terminal of switch 204C may be coupled to a second terminal of capacitor 206B and the first terminal of switch 204D. The third terminal of switch 204D may be coupled to a ground and to a second terminal of capacitor 206C. The two-to-one capacitor divider 200 may receive an input voltage from between approximately 6V and 8.4V and may output a voltage between approximately 3V and 4.2V. Input timing signals received at inputs 202B-C may be asynchronous so that switches 204A and 204C are turned on when switches 204B and 204D are turned off, and vice versa.

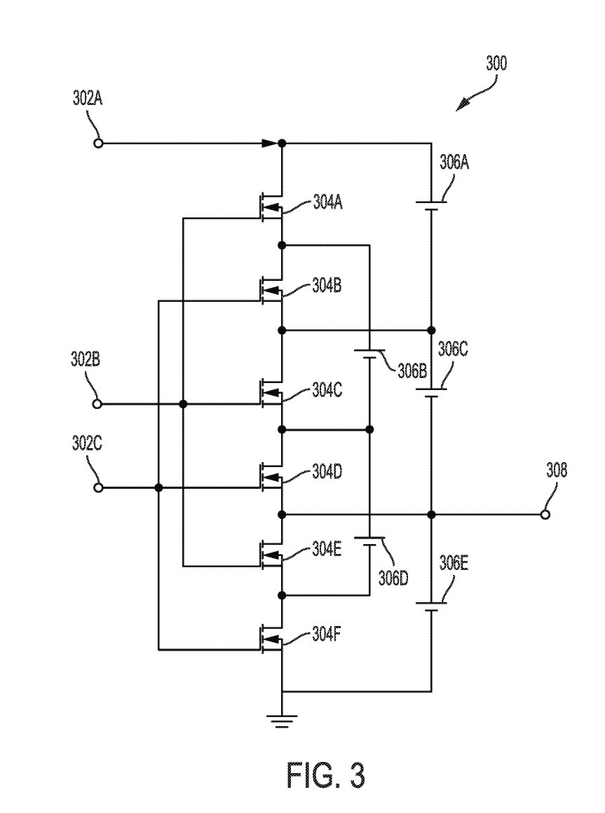

A three-cell battery may use a capacitor divider with a three-to-one divider ratio, such as capacitor divider 300 illustrated in FIG. 3, to obtain a desired output ratio. Capacitor divider 300 may receive an input voltage at input node 302A from a voltage source, such as a battery of an information handling system. The voltage input may be, for example, a voltage input from a three-cell battery between 9V and 12.6V. The capacitor divider 300 may receive timing signal inputs at input nodes 302B-C. For example, asynchronous digital pulse timing signals may be received at input node 302B and input node 302C. Input node 302A may be coupled to a first terminal of a first switch 304A and a first terminal of a capacitor 306A. Input node 302B may be coupled to a second terminal of the switch 304A to control current flowing from the first terminal to a third terminal of the switch 304A. Input node 302B may be further coupled to a second terminal of a switch 304C to control current flowing from a first terminal to a third terminal of the switch 304C. Input node 302B may be still further coupled to a second terminal of a switch 304E to control current flowing from a first terminal to a third terminal of the switch 304E. Input node 302C may be coupled to a second terminal of a switch 304B to control current flowing from a first terminal to a third terminal of the switch 304B. Input node 302C may be further coupled to a second terminal of a switch 304D to control current flowing from a first terminal to a third terminal of the switch 304D. Input node 302C may be still further coupled to a second terminal of a switch 304F to control current flowing from a first terminal to a third terminal of the switch 304F. The third terminal of the switch 304A may be coupled to a first terminal of switch 304B and a first terminal of a capacitor 306B. The third terminal of the switch 304B may be coupled to a first terminal of switch 304C, a second terminal of the capacitor 306A, and a first terminal of the capacitor 306C. The third terminal of switch 304C may be coupled to the first terminal of switch 304D, a second terminal of capacitor 306B, and a first terminal of a capacitor 306D. The third terminal of switch 304D may be coupled to a first terminal of switch 304E, a second terminal of capacitor 306C, a first terminal of a capacitor 306D, and an output 308 of the capacitor voltage divider 300. The third terminal of switch 304E may be coupled to a first terminal of switch 304F and a second terminal of capacitor 306D. The third terminal of switch 304F may be coupled to a second terminal of capacitor 306E and a ground. The three-to-one capacitor divider 300 may receive an input voltage from between approximately 9V and 12.6V and may output a voltage from between approximately 3V and 4.2V. Input timing signals received at input nodes 302B-C may be asynchronous so that switches 304A, 304C, and 304E are turned on when switches 304B, 304D, and 304F are turned off, and vice versa.

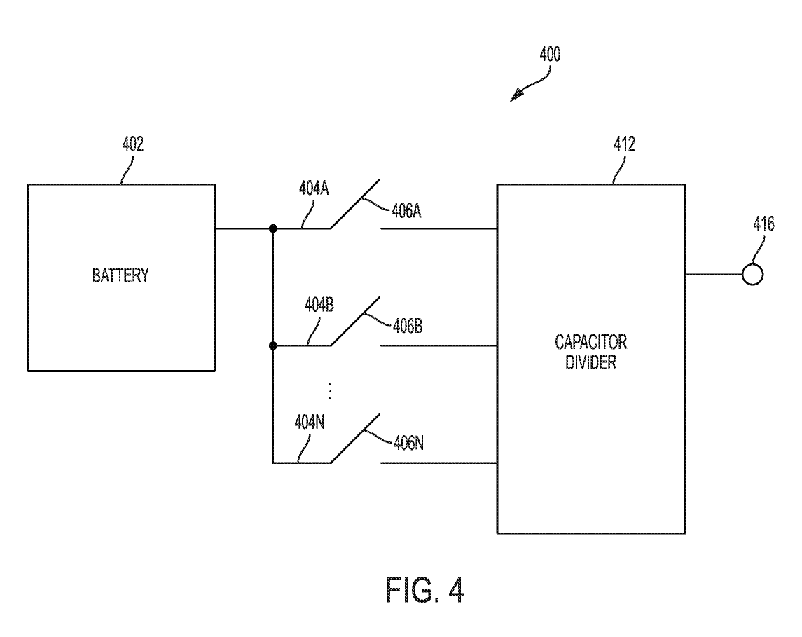

A multi-path capacitor divider may allow an information handling system to accommodate a variety of battery cell configurations and voltages using the same battery receptacle. An example multi-path capacitor divider circuit 400, illustrated in FIG. 4, may include a battery 402 and a capacitor divider 412. The battery 402 may be a two-cell battery, a three-cell battery, or another number of cells. The battery 402 may also be exchanged with a battery with a different configuration. For example, a three-cell battery may be removed and replaced with a two-cell battery. The battery 402 may be coupled to the capacitor divider 412 via multiple paths 404A-N such as a first path 404A and a second path 404B. Switches 406A-N, such as a first switch 406A and a second switch 406B, may be coupled between the battery 402 and the capacitor divider 412 along paths 404A-N respectively. Each path 404A-N may be coupled to an input of the capacitor divider 412. For example, the first path 404A and the second path 404B may be coupled to two different inputs of the capacitor divider 412. The first switch 406A may be turned on and the second switch 406B turned off when the battery 402 has a certain number of cells or a certain voltage, and the first switch 406A may be turned off and the second switch 406B turned on when the battery 402 has an alternative number of cells or an alternative voltage. A specific path of paths 404A-N may be activated, by turning on the switch of that path, for each of a number of potential battery cell configurations. For example, if the battery 402 is a three-cell battery, or a battery with a voltage within a specified voltage range, such as between 9V and 12.6V, the first switch 406A may be turned on and the second switch 406B may be turned off, along with any other switches on any additional paths of the capacitor divider circuit 400, to cause power to be transmitted from the battery 402 to the capacitor divider 412 via the first path 404A. If the battery 402 is a two-cell battery, or a battery with a voltage within a specified voltage range, such as between 6V and 8.4V, the first switch 406A may be turned off, along with any other switches on any additional paths of the capacitor divider circuit 400, and the second switch 406B may be turned on to allow power to flow from the battery 402 to the capacitor divider 412 via the second path 404B. The capacitor divider 412 may divide a voltage of power received from the battery 402 to produce an output voltage at output 416 within a range of acceptable output voltages, regardless of a voltage or number of cells of the battery 402. For example, a voltage between 3V and 5V may be output from the multi-path capacitor divider circuit 400 at output 416 to an information handling system component, such as a voltage regulator. In additional to paths for two-cell and three-cell batteries, paths 404A-N may also include paths for as single cell batteries, four-cell batteries, and batteries having greater than four cells. Regardless of the number of cells, the capacitor divider 412 may divide a voltage received from the battery 402 to produce an output voltage within a range of acceptable voltages. Thus, multiple paths from a battery to a capacitor divider may couple to multiple inputs of a capacitor divider, and the capacitor divider may output a voltage within a range of voltages regardless of the number of cells or voltage of the battery.

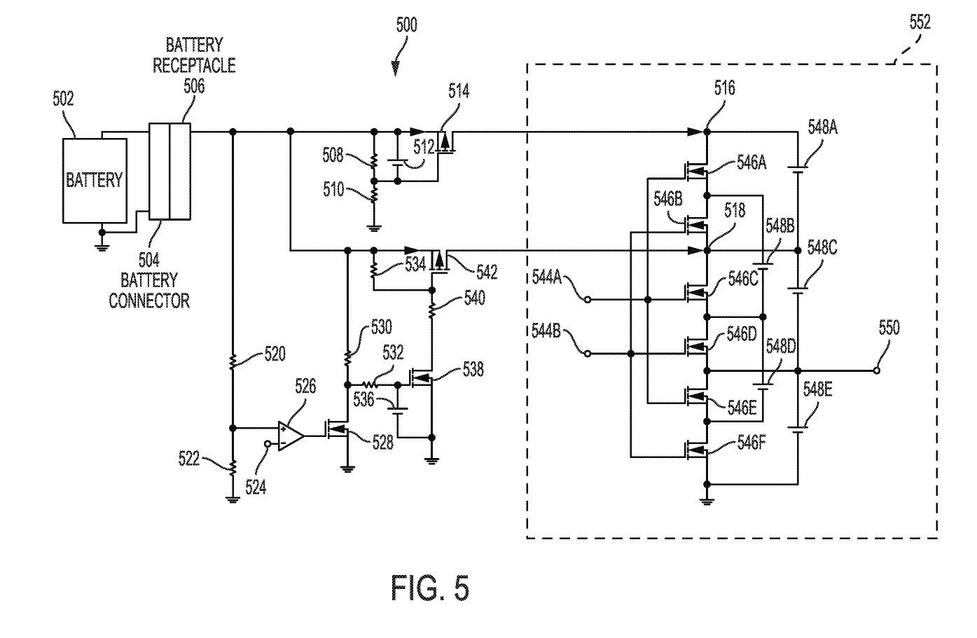

A multi-path capacitor divider may incorporate the functionality of capacitor dividers with a two-to-one divider ratio and capacitor dividers with a three-to-one divider ratio to accommodate multiple battery configurations in a single device. An example multi-path capacitor divider circuit 500 is illustrated in FIG. 5. The circuit 500 may include a battery receptacle 506 for coupling to a battery connector 504 of a battery 502. The battery 502 may, for example, be a three-cell battery or a two-cell battery. The battery receptacle 506 may be coupled to a first terminal of a first switch 514. The battery receptacle 506 may be further coupled to a first terminal of a resistor 508 and a first terminal of a capacitor 512. A second terminal of the resistor 508 may be coupled to a first terminal of a resistor 510 and a second terminal of the capacitor 512. A second terminal of the resistor 510 may be coupled to ground. The second terminal of the resistor 508, may be further coupled to a second terminal of the switch 514 to control current flowing from the first terminal to a third terminal of the switch 514. The third terminal of the switch 514 may be coupled to an input node 516 of a capacitor divider 552. Thus, current may flow from the battery 502 into the capacitor divider 552 via a first input path, from the battery receptacle 506, through switch 514, when switch 514 is turned on, and into an input node 516 of the capacitor divider 552.

Resistors 508 and 510 together may be a voltage divider with an input at the first terminal of resistor 508 and an output at the second terminal of resistor 508 and the first terminal of resistor 510. If the voltage at the output of the voltage divider is greater than a voltage threshold, the switch 514 may be turned on to allow current to flow from the first terminal to the third terminal of the switch 514. If the voltage falls below the threshold, the switch 514 may be turned off and no current may flow through the switch 514 and into the capacitor divider 552 at input node 516.

The battery receptacle 506 may also be coupled to a first terminal of a resistor 520. A second terminal of the resistor 520 may be coupled to a first input of a comparator 526 and to a first terminal of a resistor 522. The second terminal of the resistor 522 may be coupled to ground. A second input 524 of the comparator 526 may be coupled to a reference voltage, to allow the comparator 526 compare the reference voltage to the voltage received at the first input. An output of the comparator 526 may be coupled to a second terminal of a switch 528 to control current flowing from a first terminal to a third terminal of the switch 528.

Resistors 520 and 522 together may be a voltage divider with an input at the first terminal of the resistor 520 and an output at the second terminal of resistor 520 and the first terminal of resistor 522. If the voltage received at the first input of the comparator 526 from the output of the voltage divider is less than the voltage at the second input 524 of the comparator 526, the switch 528 may be turned off. If the voltage received at the first input of the comparator 526 is greater than the voltage received at the second input 524 of the comparator 526, the switch 528 may be turned on.

The battery receptacle 506 may be further coupled to a first terminal of a resistor 530. A second terminal of the resistor 530 may be coupled to the first terminal of the switch 528. The third terminal of the switch 528 may be coupled to ground. The second terminal of the resistor 530 may be further coupled to a first terminal of a resistor 532. A second terminal of the resistor 532 may be coupled to a first terminal of a capacitor 536 and to a second terminal of a switch 538, to control current flowing from a first terminal to a third terminal of the switch 538. A second terminal of the capacitor 536 and the third terminal of the switch 538 may be coupled to ground.

The battery receptacle 506 may also be coupled to a first terminal of a resistor 534 and a first terminal of a switch 542. A second terminal of the resistor 534 may be coupled to a first terminal of a resistor 540 and to a second terminal of the switch 542 to control current flowing from the first terminal to a third terminal of the switch 542. A second terminal of the resistor 540 may be coupled to the first terminal of the switch 538. The third terminal of the switch 542 may be coupled to a input node 518 of the capacitor divider 552.

When the voltage received from the battery 502 is greater than a threshold voltage, the comparator 526 may turn on switch 528 thus allowing current to flow through resistor 530 and switch 528 to ground and turning off switches 538 and 542 to prevent current from flowing from the battery 502 through switch 542 and into the capacitor divider at input node 518. At the same time, current may flow through resistor 508 and to the second terminal of switch 514, turning on the switch 514 and allowing current to flow from the battery 502, through switch 514, and into the capacitor divider at input terminal 516. Thus, when the voltage received from the battery 502 is greater than the threshold voltage, the first path may be activated, allowing current to flow through switch 514 and into the capacitor divider 552 via node 516, and the second path may be deactivated, preventing current from flowing through switch 542 and into the capacitor divider 552 via node 518.

When the voltage received from the battery 502 is less than the threshold voltage, the comparator 526 may turn off switch 528, thus causing current to flow through resistor 532 and to capacitor 536 and the second terminal of switch 538. Thus, switch 538 may be turned on, causing current to flow through resistor 534 to the second terminal of switch 542 and turning on switch 542. Current may flow from the battery 502, through switch 542 and to input node 518 of the capacitor divider 552. At the same time, switch 514 may be turned off to prevent current from flowing from the battery 502, through switch 514, and into the capacitor divider 552 via input node 516. Thus, when the voltage received from the battery 502 is less than the threshold voltage, the second path may be activated, allowing current to flow through switch 542 and into the capacitor divider 552 via node 518, and the first path may be deactivated, preventing current from flowing through switch 514 and into the capacitor divider 552 via node 516.

The capacitor divider 552 may function as a capacitor divider with a three-to-one divider ratio or a capacitor divider with a two-to-one divider ratio, depending on the voltage received from the battery 502. The capacitor divider 552 may receive a power input via the first path at node 516 and via the second path at node 518. The capacitor divider may apply a three-to-one divider ratio to a voltage of power received at input node 516 and a two-to-one divider ratio to a voltage of power received at input node 518. A further input node may allow for power to be transmitted directly from the battery 502 to the output of the capacitor divider 552 without dividing a voltage of the power. Alternatively, a capacitor divider with a different divider ratio, such as a four-to-one divider ratio, may be implemented allowing a voltage of power received by the divider to be divided by one or more additional ratios, such as a four-to-one divider ratio, in addition to a three-to-one divider ratio and a two-to-one divider ratio. The capacitor divider 552 may output power at power output node 550. Thus, power received from the battery 502 via the first path may be received by the capacitor divider 552 at input node 516, voltage of the power may be divided using a three-to-one divider ratio, and the power with the divided voltage may be output at power output 550. Power received from the battery 502 via the second path may be received by the capacitor divider at input node 518, divided using a two-to-one divider ratio, and the result output at power output 550. Power output by the capacitor divider may be within a range of voltages, such as between approximately 3V and 4.2V, regardless of the voltage received at either input node 516 or input node 518 of the capacitor divider 552.

The capacitor divider 552 may receive timing signals at inputs 544A-B. For example, asynchronous digital pulse timing signals may be received input node 544A and input node 544B. Input node 516 may be coupled to a first terminal of a first switch 546A and a first terminal of a first capacitor 548A. Input node 544A may be coupled to a second terminal of the switch 546A to control current flowing from the first terminal to a third terminal of the switch 546A. Input node 544A may be further coupled to a second terminal of a switch 546C to control current flowing from a first terminal to a third terminal of the switch 546C. Input node 544A may be still further coupled to a second terminal of a switch 546E to control current flowing from a first terminal to a third terminal of the switch 546E. Input node 544B may be coupled to a second terminal of a switch 546B to control current flowing from a first terminal to a third terminal of the switch 546B. Input node 544B may be further coupled to a second terminal of a switch 546D to control current flowing from a first terminal to a third terminal of the switch 546D. Input node 544B may be still further coupled to a second terminal of a switch 546F to control current flowing from a first terminal to a third terminal of the switch 546F. The third terminal of the switch 546A may be coupled to a first terminal of switch 546B and a first terminal of a capacitor 548B. The third terminal of the switch 546B may be coupled to a first terminal of switch 546C, a second terminal of the capacitor 548A, a first terminal of the capacitor 548C. Furthermore, input node 518 may be located between the third terminal of switch 546B and the first terminal of switch 546C. The third terminal of switch 546C may be coupled to the first terminal of switch 546D, a second terminal of capacitor 548B, and a first terminal of a capacitor 548D. The third terminal of switch 546D may be coupled to a first terminal of switch 546E, a second terminal of capacitor 548C, a first terminal of a capacitor 548E, and an output 550 of the capacitor divider 552. The third terminal of switch 546E may be coupled to a first terminal of switch 546F and a second terminal of capacitor 548D. The third terminal of switch 546F may be coupled to a second terminal of capacitor 548E and a ground. The capacitor divider 552 may, for example, receive an input voltage from below 9V to above 12.6V, at input node 516, and may output a voltage from below 3V to above 4.2V. Alternatively, the capacitor divider 552 may receive an input voltage from between approximately 6V and 8.4V, at node 518, and may output a voltage from between approximately 3V and 4.2V. Timing signals received at inputs 544A-B may be asynchronous so that switches 546A, 546C, and 546E are turned on when switches 546B, 546D, and 546F are turned off, and vice versa.

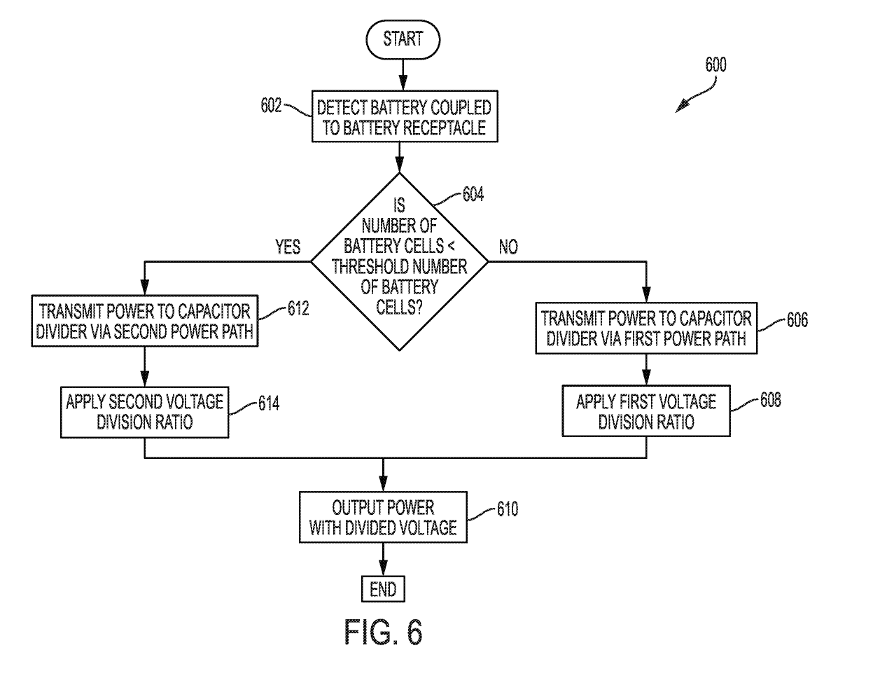

A multi-path capacitor divider may divide a voltage received from a battery based on a number of cells of a battery. An example method 600 for dividing a voltage of a battery based on a number of cells of the battery is illustrated in FIG. 6. The method may begin, at step 602, with detection of a battery coupled to a battery receptacle. For example, a portable information handling system, such as a laptop, may detect a battery, such as a laptop battery, coupled to the information handling system.

When a battery has been detected, at step 602, a determination may be made, at step 604 of whether a number of cells of the battery is less than a threshold number of cells. Batteries may, for example, have a single cell, two cells, three cells, or more than three cells. A system may support two-cell and three-cell batteries, with a cell threshold of three cells. One method to determine whether a number of cells of a battery is less than a threshold number of cells is to determine if a voltage of the battery is less than a threshold voltage. For example, a three-cell battery may typically fall within a voltage range, such as from 9V-12.6V, and a two-cell battery may typically fall within another voltage range, such as from 6V-8.4V. A voltage threshold may therefore be set at a voltage level, such as 8.5V, to distinguish between a three-cell battery and a two-cell battery. If the voltage of the battery is less than 8.5V, then the number of cells of the battery may be less than three cells. If the voltage of the battery is greater than 8.5V, the number of cells of the battery may be three or more. Thus, a determination may be made whether a number of cells is less than a threshold number of cells.

If the number of cells, determined at step 604, is not less than the threshold number of cells, power may be transmitted to a capacitor divider via a first power path, at step 606. For example, if the number of cells of the battery is three or more, power may be transmitted to the capacitor divider via the first power path. The first power path may be coupled to the capacitor divider at a first capacitor divider input. The capacitor divider may then apply a first voltage division ratio, at step 608, to the power received. For example, the capacitor divider may divide a voltage of power received at the first input by three. Thus, a voltage of power received from three cell batteries, for example a voltage from 9V-12.6V, may be divided by three. The capacitor divider circuit may then output power with the divided voltage, at step 618. For example, power with a voltage of approximately 3V to 4.2V may be output.

If the number of cells of the battery, determined at step 604, is less than the threshold number of cells, power may be transmitted to the capacitor divider via a second power path, at step 612. For example, if the number of cells of the battery is less than three, power may be transmitted to the capacitor divider via the second power path. The second power path may be coupled to the capacitor divider at a second capacitor divider input. The capacitor divider may then apply a second voltage division ratio, at step 614, to the power received. For example, the capacitor divider may divide a voltage of power received at the second input by two. Thus, a voltage of power received from two cell batteries may be divided by two. The capacitor divider circuit may then output power with the divided voltage, at step 618. For example, power with a voltage of approximately 3V to 4.2V may be output.

Additional power paths for batteries with different numbers of cells may also transmit power from the battery to the capacitor divider. For example, a power path may transmit power for single cell batteries directly to an output, without the need to apply a divider ratio to a voltage of the power. A power path for a four-cell battery may transmit power to the capacitor divider, and the capacitor divider may divide a voltage of the power by four and output power with the divided voltage. To select a power path in an embodiment with more than two power paths, a determination may be made of whether a number of cells is greater than a first threshold and whether a number of cells is less than a second threshold. A number of cells may also be compared to additional thresholds, beyond the first threshold and the second threshold, if more than three power paths are present.

The schematic flow chart diagram of FIG. 6 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An apparatus, comprising:
a battery receptacle for receiving a battery comprising a plurality of cells;
a capacitor divider configured to divide a voltage output of the battery and to output the divided voltage at an output of the capacitor divider;
a first discharge path from the battery receptacle to the capacitor divider, wherein the first discharge path is coupled to the capacitor divider; and
a second discharge path from the battery receptacle to the capacitor divider, wherein the second discharge path is coupled to the capacitor divider and is configured to activate when a number of cells of the battery is below a first threshold number of cells.

2. The apparatus of claim 1, wherein the first discharge path is configured to activate when the number of cells is greater than or equal to the first threshold number of cells.

3. The apparatus of claim 1, wherein the first threshold number of cells is three.

4. The apparatus of claim 1, wherein the number of cells of the battery is indicated by a voltage of the battery, wherein the first threshold number of cells is indicated by a threshold voltage, and wherein the second discharge path is configured to activate when the voltage of the battery is less than the threshold voltage.

5. The apparatus of claim 4, further comprising a comparator, and wherein the comparator is used to compare the voltage of the battery with the threshold voltage.

6. The apparatus of claim 1, wherein the first discharge path is coupled to a first node of the capacitor divider and the second discharge path is coupled to a second node of the capacitor divider.

7. The apparatus of claim 1, wherein the first discharge path applies a first divider ratio of the capacitor divider to the voltage output of the battery and the second discharge path applies a second divider ratio of the capacitor divider to the voltage output of the battery.

8. The apparatus of claim 1, further comprising a third discharge path from the battery receptacle to the capacitor divider, wherein the third discharge path is coupled to the capacitor divider and is configured to activate when the number of cells is greater than a second threshold number of cells and wherein the first path is configured to activate when the number of cells is greater than the first threshold number of cells but less than the second threshold number of cells.

9. The apparatus of claim 1, wherein the output of the capacitor divider is coupled to an input of a voltage regulator.

10. The apparatus of claim 1, wherein the divided voltage is within a predetermined range of voltages irrespective of the number of cells of the battery.

11. An information handling system, comprising:
a battery receptacle;
a voltage regulator;
a capacitor divider configured to divide a voltage output of a battery coupled to the battery receptacle and to output the divided voltage to the voltage regulator at an output of the capacitor divider;
a first discharge path from the battery receptacle to the capacitor divider, wherein the first discharge path is coupled to the capacitor divider; and
a second discharge path from the battery receptacle to the capacitor divider, wherein the second discharge path is coupled to the capacitor divider and is configured to activate when a number of cells of the battery is below a first threshold number of cells.

12. The system of claim 11, wherein the first threshold number of cells is three.

13. The system of claim 11, wherein the number of cells of the battery is indicated by a voltage of the battery, wherein the first threshold number of cells is indicated by a threshold voltage, and wherein the second discharge path is configured to activate when the voltage of the battery is less than the threshold voltage.

14. The system of claim 13, further comprising a comparator, and wherein the comparator is configured to compare the voltage of the battery with the threshold voltage.

15. The system of claim 11, wherein the first discharge path is coupled to a first node of the capacitor divider and the second discharge path is coupled to a second node of the capacitor divider.

16. The system of claim 11, wherein the first discharge path applies a first divider ratio of the capacitor divider to the voltage output of the battery and the second discharge path applies a second divider ratio of the capacitor divider to the voltage output of the battery.

17. The system of claim 11, further comprising a third discharge path from the battery receptacle to the capacitor divider, wherein the third discharge path is coupled to the capacitor divider and is configured to activate when the number of cells is greater than a second threshold number of cells and wherein the first path is configured to activate when the number of cells is greater than the first threshold number of cells but less than the second threshold number of cells.

18. A method, comprising:
determining whether a number of cells of a battery is less than a threshold number of cells;
if the number of cells of the battery is not less than the threshold number of cells, transmitting power via a first discharge path from the battery to a capacitor divider configured to divide a voltage output of the battery and to output the divided voltage at an output of the capacitor divider; and
if the number of cells of the battery is less than the threshold, activating a second discharge path from the battery to the capacitor divider and transmitting power from the battery to the capacitor divider via the second discharge path.

19. The method of claim 18, wherein the step of determining comprises:
determining a voltage of the battery; and
comparing the voltage of the battery with a threshold voltage of the battery.

20. The method of claim 18, wherein the step of transmitting power via the first discharge path comprises transmitting power from the battery to a first node of the capacitor divider and wherein transmitting power via the second discharge path comprises transmitting power from the battery to a second node of the capacitor divider, different from the first node.
